(19) United States
(12) Patent Application Publication
(10) Pub. No.: US 2006/0167907 A1
(43) Pub. Date: Jul. 27, 2006

(54) System and method for processing XML documents

(76) Inventor: Kevin Jones, Harrogate (GB)

Correspondence Address: Welsh & Katz, Ltd.;Jon P. Christensen, 22nd Floor, 120 South Riverside Plaza, Chicago, IL, 60606, US

(21) Appl. No.: 11/340,987

(22) Filed: Jan. 27, 2006

Related U.S. Application Data
(60) Provisional application No. 60/647,634, filed on Jan. 27, 2005.

(51) Int. Cl. G06F 7/00; G06F 17/21

(52) U.S. Cl. 707/100; 715/513

(57) ABSTRACT

A method and apparatus are provided for representing an XML document in a collection of ordered information items. The method includes the steps of providing an information item of the collection of ordered information items encoded as a series of records where each record is provided with a length field at a beginning and at an end of the record and processing at least a portion of the series of records, upon occasion, in a forward direction and, upon occasion, in a reverse direction based upon use of the length fields at the beginning and end of a record of the portion of the series of records.

### FIELD OF THE INVENTION

The field of the invention relates to the encoding of documents and more particularly to encoding of documents under the XML format.

### BACKGROUND OF THE INVENTION

Extensible Markup Language (XML) is a standardized text format that can be used for transmitting structured data to web applications. In this regard, XML offers significant advantages over Hypertext Markup Language (HTML) in the transmission of structured data.

In general, XML differs from HTML in at least three different ways. First, in contrast to HTML, users of XML may define additional tag and attribute names at will. Second, users of XML may nest document structures to any level of complexity. Third, optional descriptors of grammar may be added to XML to allow for the structural validation of documents. In general, XML is more powerful, is easier to implement and easier to understand.

However, XML is not backward-compatible with existing HTML documents, but documents conforming to the W3C HTML 3.2 specification can be easily converted to XML, as can documents conforming to ISO 8879 (SGML). Further, while XML allows for increased flexibility, documents created under XML do not provide a convenient mechanism for searching or retrieval of portions of the document. Where large numbers of XML documents are involved, considerable time may be consumed searching for small portions of documents.

For example, in a business environment, XML may be used to efficiently encode information from purchase orders (PO). However, where a search must later be performed that is based upon certain information elements within the PO, the entire document must be searched before the information elements may be located. Because of the importance of information processing, a need exists for a better method of searching XML documents.

### SUMMARY

A method and apparatus are provided for representing an XML document in a collection of ordered information items. The method includes the steps of providing an information item of the collection of ordered information items encoded as a series of records where each record is provided with a length field at a beginning and at an end of the record and processing at least a portion of the series of records, upon occasion, in a forward direction and, upon occasion, in a reverse direction based upon use of the length fields at the beginning and end of a record of the portion of the series of records.

### BRIEF DESCRIPTION OF THE DRAWINGS

FIG. 1 is a block diagram of a system for processing an XML document in accordance with an illustrated embodiment of the invention.

### DETAILED DESCRIPTION OF AN ILLUSTRATED EMBODIMENT

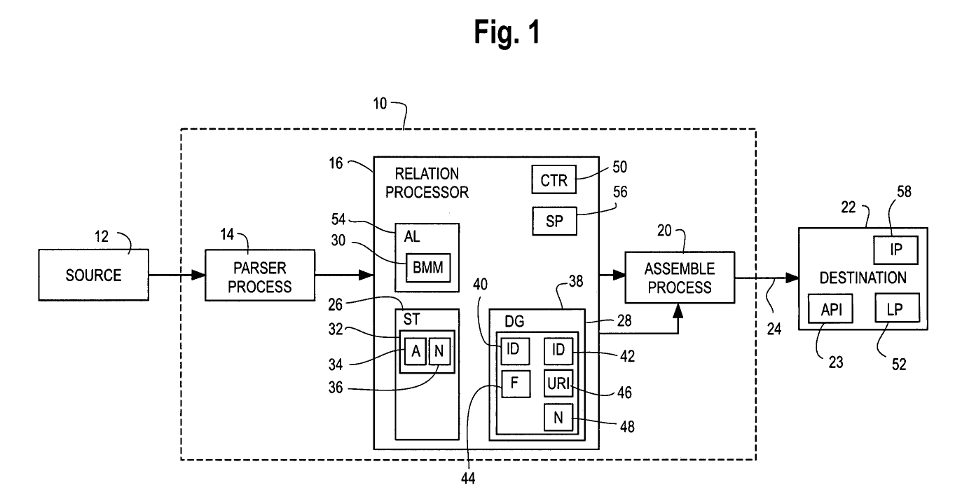

FIG. 1 depicts a system 10 for creating an Event Stream (ES) 24 from a representation of an XML document, shown generally, under an illustrated embodiment of the invention. As used herein, a representation of an XML document may be a conventional XML document formatted as described by the World Wide Web Consortium (W3C) document Extensible Markup Language (XML) 1.0. The representation of the XML document may also be a Document Object Model of the XML document or a conversion of the XML document using an application programming interface (API) (e.g., using the “Simple API for XML” (SAX)).

An Event Stream may consist of an ordered sequence of information items of a conventional XML Document, plus a series of short-hand references and navigational records. Unlike a conventional XML Document, the information items in an Event Stream are encoded in a manner that can be efficiently processed using a common XML processing API (Application Programming Interface).

The ES format is most closely related to a serialization of the output of an XML parser, except as noted below. In that respect, it has a number of similarities to some of the encoding characteristics of the SAX interface. In addition to forward iteration through the data, the ES format supports reverse iteration. The ES may also use a symbol table 26 for XML names and a structural summary of the encoded document.

While the ES described below is defined as a data format, its use is supported by an application library 54 that provides additional features. The memory management for each ES stream is pluggable allowing for streams to be wholly maintained in main memory or paged or streamed as needed by an application. The library also provides a bookmark model 30 that may locate an individual event in any loaded ES stream via a single 8-byte marker.

It should be recognized that the ES format is not designed to provide compression with respect to the original document size as is common with XML encoding's. One significant advantage of ES is to enable efficient iteration over the encoded data while not imposing an excessive format construction cost. In general ES streams are generally directly comparable in size to the original document.

An overview of the ES event format will be provided first. The ES format is generated by a relationship processor 16 and assembly processor 20 that serialize post parse XML information items based upon recognition of a series of events that may each result in the insertion of one or more records into the ES 24.

The occurrence of an event may result in a series of steps being performed that creates the elements of the ES 24. It should be noted that as used herein, reference to a step also refers to the structure (i.e., the computer application) that performs that step.

The format starts with the insertion of a header and continues with the introduction of variable and fixed length ‘event’ records into the ES 24. The events may be of one of two types, external or internal. An external event corresponds to an information item that should be reported to an application 23 reading a stream while internal events are used to maintain decoding data structures. All of the event records have a common encoding format that consists of the event length, the event type, the event data and the event length again. The event length does not include the size used to encode the preceding and following lengths themselves, just the event data.

The presence of the event lengths in the ES 24 allows an iteration processor 58 at a destination 22 to iterate in either a forward or reverse direction. A symbol table and data guide function as navigational aids to the iteration processor 58.

At the beginning of a document, the relationship processor 16 inserts an ES header. The ES header contains a 4-byte identifier “ESII” byte swapped to create 0x45524949 and a 4-byte version number stored in network byte order. The relationship processor 16 also activates a stream counter 50. The stream counter 50 may be used to determine offsets and event lengths.

Following the header, the relationship processor 16 inserts a start record. The first event record is always a start document event while the last event record is always an end document event.

Size and offset values written from the stream counter 50 into the ES 24 (e.g., into a start record) under the format are 64 bit values to allow the encoding of very large streams. These values are encoded using a 7-bits to a byte model with the most significant bit being used as a continuation marker. Values less then 128 are thus encoded as a single byte containing the value, larger values are stored over multiple bytes with all but the last having the highest bit set. Each continuation byte contains the next most significant 7 bits of the encoded value up to the maximum of 10 bytes.

The symbol table 26 and data guide 28 will be discussed next. The symbol table and data guide (a structural summary of the document) are notionally in-memory data structures that provide metadata on the document. As used herein, the term “data guide” refers to a data guide similar to that described by R. Goldman and J. Widom in “Enabling Query Formulation and Optimization in Semistructured Databases (Proceedings of the 23^{rd} VLDB Conf., pages 436-445 (1997)). The reader should note in this regard, that the data guide of R. Goldman and J. Widom was used for databases and therefore constitutes a substantially different purpose and context than the data guide described herein.

The structures of the symbol table and data guide may be generated during the ES encoding phase and be used to substitute atoms for names, element/attribute or uri/name pairs. (As used herein, an “atom” is to a short-hand reference used in the ES 24 to refer to an element/attribute name pair or universal resource locator (uri)/name pair within the symbol table and data guide table.) In this case, a substitution processor 56 substitutes atoms for element/attribute uri/name pairs into the ES 24. At a destination 22, the structures may be used independently by ES processing applications for other purposes such as for reducing the search space of a query.

The structures of the symbol table and data guide present a difficulty during construction in that they cannot be completed until the whole document has been parsed. This means that they could not be written in their entirety until after all other ES events have been encoded. This would create a problem for applications receiving a ES stream, as decoding could not start until after the whole stream had been received and these structures had been re-created.

The solution employed in the ES 24 is that the relationship processor 16 encodes the structures 26, 28 incrementally during the encoding of the document and inserts the encoded symbol table and data guide records into the ES stream as they are created. This means that an application receiving an ES stream can incrementally re-construct the two data structures as it processes the stream. Alternatively where streaming functionality is not required, e.g. in-process, then the symbol table and data guide created during document encoding can be passed directly to the recipient if appropriate thereby avoiding the overhead of reconstruction.

The internal events record encoded by the system 10 will be discussed next. The internal events encoded in a stream are used to describe the symbol table, data guide & maintain correct error handling semantics.

If ES data is being streamed between processes, then the question arises of how to handle an error occurring in the encoding (e.g., a parser error due to an invalid document). Given that the ES 24 only defines a data format there is no obvious way to directly communicate errors to the stream recipient. Instead, errors reported during encoding are encoded as events (error records) under the ES format. As the recipient processes the stream any error events will be discovered and can be reported to the recipient just as though the recipient in directly parsing the input document had found the error. The format for error events consists of the ES ERROR event code followed by an error message in UTF-8 string format.

As mentioned earlier, XML names are replaced by atom values obtained from the symbol table 26. If a new name 36 is discovered during encoding it is assigned a unique value 34 within a symbol table name pair entry 32 of the symbol table 26 and an event (name pair record) is added to the data stream to record the association between atom value and name. The event consists of the ES_SYMBOL event code followed by the encoded atom value, the encoded size of the symbol and the symbol in UTF-8 string format.

To aid receivers that have difficulty handling UTF-8 a distinction is made during encoding between symbols containing just ASCII characters and those that contain characters outside the ASCII range. ASCII only symbols are recorded with the event ES_SYMBOL_ASCII that has substantially the same structure as a ES_SYMBOL event. Only a limited number of bytes are checked to determine if a string is ASCII meaning that large strings will be marked ES_SYMBOL (i.e., not ASCII) even if they contain only ASCII characters.

The final internal event used by the ES format is the ES_DG event. This encodes an addition to the data guide and into the ES 24 in the same manner that ES_SYMBOL adds to the symbol table and ES 24. The data guide is structured as a tree of entries, where each entry represents the occurrence of an element (information item) or attribute of an element and is recorded as a child of the element that is associated with the parent data guide entry. Thus every element or attribute of the encoded document has an associated entry record 38 in the data guide 28 and elements/attributes that have the same ancestor structure share the same data guide entry 38. To aid quick lookup (e.g., by a locating processor 52 at a destination 22) all data guide entries are assigned a unique identifier 40 that can be used to index the entries in a table. The format of the ES_DG event is entry id 40, the id of the parent entry 42, a flag 44 indicating if this is a element or attribute entry followed by the symbol table identifiers for the uri 46 and name 48 of the element or attribute.

ES uses data guide entries (records) to encode element & attribute details. In this respect the data guide acts as a lookup table for uri/name pairs (e.g., given that a data guide entry identifier 40 for an element is known it is a trivial matter to resolve the uri 46 and name symbols 48 used on that element).

The start and end events of the XML stream will be discussed next. The start and end document event records are simple markers used to determine the start and end of the data stream being traversed. Each event carries no data items and so is encoded directly as either ES_START_DOCUMENT or ES_END_DOCUMENT.

The start and end element events (records) will be discussed next. The start of an element within the stream 24 is marked with an event record containing the ES_START_ELEMENT marker, the Data guide entry identifier for the element type, a symbol table identifier for the prefix (or “ ” if no prefix was used) and the encoded offset to the parent entry record in the stream.

Immediately following the start element record will be any namespace records declared on that element followed by any attribute records of that element. This ordering has been chosen so that it matches the ‘document order’ define by XPath, i.e. sorting elements with respect to their offset in the stream also sorts them into XPath document order.

After the element name space records and attribute records follows any child content records such as text node records or child element records. At the end of the child events is an end element event record, marked with ES_END_ELEMENT. The end element contains the data guide entry index record for the element being closed.

The parent entry offset record may be included within each child event to allow for quick navigation to ancestors, say during XSLT pattern matching or resolution of in-scope namespaces. In practice, many applications 23 may choose to cache ancestor event information in memory as this is relatively cheap to perform where element nesting is not excessive.

Namespaces will be discussed next. Each declared namespace is indicated with an ES_NAMESPACE mark record following the element it was declared on. The namespace event contains the symbol table index for the namespace name and uri. The XML namespace is not explicitly declared as an event but is implicitly declared by both encoder and decoder for the ES 24 (e.g., The prefix ‘xml’ can be resolved on any ES stream).

It is also worth noting that the binding between an element or attribute and the namespaces declaration that provides a valid prefix for it is not preserved. The element/attribute only contains that resolved uri and prefix, although the namespace declaration that was in-scope to provide the uri can be located by searching the event ancestor events.

Attributes will be discussed next. Attribute declaration records use the ES_ATTRIBUTE mark. Like element records they contain the data guide entry identifier for the element type, a symbol table identifier for the prefix (or “ ” if no prefix was used). In addition, they also contain the value of the attribute as a UTF-8 encoded string. The encoded length of the string precedes the value, as it is not NULL terminated.

Text or character data will be discussed next. Text events are split in a similar way to symbol table entries into ASCII (ES_TEXT_ASCII) only and non-ASCII (ES_TEXT) versions to aid the receiver. The event data for both these event records contains the encoded length of the string followed by the string itself. There is no separate representation for cdata sections so these will also appear as text events in the encoding.

Comments will be discussed next. Comments are encoded in an identical manner to text event records but using the ES_COMMENT marker.

Processing instructions will be discussed next. Each processing instruction is encoded as an instruction record with the ES_PI marker followed by a symbol table identifier for the target of the processing instruction. The data of the instruction is written as an encoded string length followed by the data string itself in UTF-8 format.

Buffering of the ES stream will be discussed next. If an ES data stream is transmitted between two applications as a stream it can be difficult to manage the decoding of a stream where individual events may be arbitrarily split across buffers. This difficulty can lead to less efficient decoding strategies than would be possible if there is some agreement over buffer sizing between the applications. In the ES 24 there is an internal alignment multiple that is used to place events such that the receiver does not have to perform buffer boundary checks for most data access of the stream. This alignment may be provided on 4 k byte boundaries. If an event that has a fixed maximum size would cross a boundary then the stream is padded to the boundary and the event is written in complete form after the boundary.

There are a number of event records for which there is no fixed maximum size. In these cases the events may be defined such that the variable component always comes at the end. Thus for these events if the part that has a fixed maximum size cannot be written before a boundary re-occurs, then the stream is padded and the event is written after the boundary. The variable parts of these events can be written at any point in the stream and can span any boundary encountered in so doing.

This rather complex set of guarantees can be used by a receiver that uses a multiple of the boundary size to make key assumptions about location of events it is reading. Namely, the next/last event will either have all its critical data in this buffer or the next/last. In practice, this means that buffer boundary checking is performed only once per-event not once-per data item read while only restricting the encoder and receiver to use of a multiple of the 4K byte boundary size.

One extra consideration is that to handle small documents efficiently the last buffer (or only buffer) can be a multiple of a 1K boundary. Hence the minimum encoded stream size is 1K.

The creation of the ES 24 from the XML parser events will be discussed next. The following Table I summarizes the processing steps to create the navigation records inserted into an ES data stream 24 by the assembly processor 20. On the left hand side is listed the incoming events normally provided by a XML parser. On the right hand side is the action taken by the processor 16 in response to each event to produce the ES 24.

A side effect of the actions is the production of a symbol table 26 and data guide 28 that may or may not be reused for other types of processing.

TABLE I

| | |
|---|---|
| Start of Document | Write on output stream, |
| | Format identifier |
| | Version identifier |
| | Start document record |
| | Add symbols for, |
| | Empty string |
| | XML namespace URI |
| End of document | Write on output stream, |
| | End document record |
| Start namespace | Add symbols for prefix and name |
| | Cache namespace details |
| End namespace | No action |
| Start element | Add symbol for name |
| | Locate symbol for namespace |
| | Add data guide entry for element |
| | Calculate offset from current element to parent |
| | Write on output stream start element record |
| | For each cached namespace |
| | Write on output stream a namespace record |
| | For each attribute of the element |
| | Add symbol for attribute name |
| | Locate symbol for attribute namespace |
| | Add data guide entry for attribute |
| | Write on output stream an attribute record |
| End element | Write on output stream end element record |
| Character data | If last record was character data and can be extended |
| | Extend record with new data |
| | Else |
| | Write character data event |
| Comment | Write on output stream comment record |
| Processing | Add symbol for target of processing instruction |
| instruction | Write on output stream processing instruction record |
| CDATA Section | As per character data |

A specific embodiment of method and apparatus for representing an XML document has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of processing an XML document where the XML document is represented in a collection of ordered information items, such method comprising:
providing an information item of the collection of ordered information items encoded as a series of records where each record is provided with a length field at a beginning and at an end of the record; and
iterating at least a portion of the series of records, upon occasion, in a forward direction and, upon occasion, in a reverse direction based upon use of the length fields at the beginning and end of a record of the portion of the series of records.

2. The method of processing the XML document as in claim 1 wherein the step of iterating further comprises waiting until the document is resident in a memory of a data processing device.

3. The method of processing the XML document as in claim 1 wherein the step of iterating further comprises iterating in either the forward or reverse direction as the portion of the document is received by a data processing device.

4. The method of processing the XML document as in claim 1 further comprising providing an offset of a parent information item from a child information item of the collection of ordered information items within a record of the series of records.

5. The method of processing the XML document as in claim 4 further comprising directly traversing from the child information item to the parent information item based upon the offset.

6. The method of processing the XML document as in claim 1 further comprising providing a symbol table that contains names of items of the collection of ordered information items and assigning a unique value for use as a short-hand reference in place of a name associated with, or name contained within, the information element of the collection of ordered information items.

7. The method of processing the XML document as in claim 6 further comprising substituting the short-hand reference for the name associated with, or name contained within, at least some of the information items of the collection of ordered information items.

8. The method of processing the XML document as in claim 1 further comprising providing a data guide structural summary that contains a namespace uri and name pair of at least some information items of the collection of ordered information items where each such pair has been assigned a unique value.

9. The method of processing the XML document as in claim 8 further comprising substituting the unique value of the data guide structural summary as a short-hand reference in place of the name pair of the at least some information items.

10. A method of processing an XML document wherein the XML document is represented in a collection of ordered information items, such method comprising:
providing an offset of a parent information item from a child information item of the collection of ordered information items within a record of the series of records; and
directly traversing from the child information item to the parent information item based upon the offset.

11. The method of processing the XML document as in claim 10 wherein the step of traversing further comprises waiting until the document is resident in a memory of a data processing device.

12. The method of processing the XML document as in claim 10 wherein the step of traversing further comprises iterating in either the forward or reverse direction as the portion of the document is received by a data processing device.

13. The method of processing the XML document as in claim 10 further comprising providing a symbol table that contains names of items of the collection of ordered information items and assigning a unique value for use as a short-hand reference in place of a name associated with, or name contained within, the information element of the collection of ordered information items.

14. The method of processing the XML document as in claim 13 further comprising substituting the short-hand reference for the name associated with, or name contained within, at least some of the information items of the collection of ordered information items.

15. The method of processing the XML document as in claim 10 further comprising providing a data guide structural summary that contains a namespace uri and name pair of at least some information items of the collection of ordered information items where each such pair has been assigned a unique value.

16. The method of processing the XML document as in claim 15 further comprising substituting the unique value of the data guide structural summary as a short-hand reference in place of the name pair of the at least some information items.

17. A method of processing an XML document wherein the XML document is represented in a collection of ordered information elements, such method comprising:
providing a symbol table that contains the names of elements of the ordered information elements;
assigning a unique value for use as a short-hand reference in place of a name associated with or name contained in the information element of the collection of ordered information elements;
substituting the short-hand reference for the name associated with or name contained in the information element of the collection of ordered information elements into the information element.

18. The method of processing the XML document as in claim 17 further comprising providing an information item of the collection of ordered information items encoded as a series of records where each record is provided with a length field at a beginning and at an end of the record and processing at least a portion of the series of records, upon occasion, in a forward direction and, upon occasion, in a reverse direction based upon use of the length fields at the beginning and end of a record of the portion of the series of records.

19. The method of processing the XML document as in claim 18 wherein the step of iterating further comprises waiting until the document is resident in a memory of a data processing device.

20. The method of processing the XML document as in claim 18 wherein the step of iterating further comprises iterating in either the forward or reverse direction as the portion of the document is received by a data processing device.

21. The method of processing the XML document as in claim 17 further comprising providing a data guide structural summary that contains a namespace uri and name pair of at least some information items of the collection of ordered information items where each such pair has been assigned a unique value.

22. The method of processing the XML document as in claim 21 further comprising substituting the unique value of the data guide structural summary as a short-hand reference in place of the name pair of the at least some information items.

23. A method of processing the XML document in a collection of ordered information items, such method comprising:
providing a data guide structural summary that contains the namespace uri and name pair of information items where each such pair being assigned a unique value; and
using the data guide structural summary as a short-hand reference in place of the namespace uri and name pair contained in the information item.

24. An apparatus for processing an XML document wherein the XML document is represented in a collection of ordered information items, such apparatus comprising:
means for providing an information item of the collection of ordered information items encoded as a series of records where each record is provided with a length field at a beginning and at an end of the record; and
means for processing at least a portion of the series of records, upon occasion, in a forward direction and, upon occasion, in a reverse direction based upon use of the length fields at the beginning and end of a record of the portion of the series of records.

25. The apparatus for processing the XML document as in claim 24 wherein the means for processing further comprises means for waiting until the document is resident in a memory of a data processing device.

26. The apparatus for processing the XML document as in claim 24 wherein the means for processing further comprises means for iterating in either the forward or reverse direction as the portion of the document is received by a data processing device.

27. The apparatus for processing the XML document as in claim 24 further comprising means for providing an offset of a parent information item from a child information item of the collection of ordered information items within a record of the series of records.

28. The apparatus for processing the XML document as in claim 25 further comprising means for directly traversing from the child information item to the parent information item based upon the offset.

29. The apparatus for processing the XML document as in claim 24 further comprising means for providing a symbol table that contains names of items of the collection of ordered information items and assigning a unique value for use as a short-hand reference in place of a name associated with, or name contained within, the information element of the collection of ordered information items.

30. The apparatus for processing the XML document as in claim 29 further comprising means for substituting the short-hand reference for the name associated with, or name contained within, at least some of the information items of the collection of ordered information items.

31. The apparatus for processing the XML document as in claim 24 further comprising means for providing a data guide structural summary that contains a namespace uri and name pair of at least some information items of the collection of ordered information items where each such pair has been assigned a unique value.

32. The method of processing the XML document as in claim 31 further comprising means for substituting the unique value of the data guide structural summary as a short-hand reference in place of the name pair of the at least some information items.

33. An apparatus for processing the XML document in a collection of ordered information items, such apparatus comprising:
means for providing an offset of a parent information item from a child information item of the collection of ordered information items within a record of the series of records; and
means for directly traversing from the child information item to the parent information item based upon the offset.

34. The apparatus for processing the XML document as in claim 33 wherein the means for traversing further comprises means for waiting until the document is resident in a memory of a data processing device.

35. The apparatus for processing the XML document as in claim 33 wherein the means for traversing further comprises means for iterating in either the forward or reverse direction as the portion of the document is received by a data processing device.

36. The apparatus for processing the XML document as in claim 33 further comprising means for providing a symbol table that contains names of items of the collection of ordered information items and assigning a unique value for use as a short-hand reference in place of a name associated with, or name contained within, the information element of the collection of ordered information items.

37. The apparatus for processing the XML document as in claim 36 further comprising means for substituting the short-hand reference for the name associated with, or name contained within, at least some of the information items of the collection of ordered information items.

38. The apparatus for processing the XML document as in claim 33 further comprising means for providing a data guide structural summary that contains a namespace uri and name pair of at least some information items of the collection of ordered information items where each such pair has been assigned a unique value.

39. The apparatus for processing the XML document as in claim 38 further comprising means for substituting the unique value of the data guide structural summary as a short-hand reference in place of the name pair of the at least some information items.

40. An apparatus for processing an XML document where the XML document is represented in a collection of ordered information elements, such method comprising:
means for providing a symbol table that contains the names of elements of the ordered information elements;
means for assigning a unique value for use as a short-hand reference in place of a name associated with or name contained in the information element of the collection of ordered information elements;
means for substituting the short-hand reference for the name associated with or name contained in the information element of the collection of ordered information elements into the information element.

41. The apparatus for processing the XML document as in claim 40 further comprising means for providing an information item of the collection of ordered information items encoded as a series of records where each record is provided with a length field at a beginning and at an end of the record and processing at least a portion of the series of records, upon occasion, in a forward direction and, upon occasion, in a reverse direction based upon use of the length fields at the beginning and end of a record of the portion of the series of records.

42. The apparatus for processing the XML document as in claim 41 wherein the means for iterating further comprises means for waiting until the document is resident in a memory of a data processing device.

43. The apparatus for processing the XML document as in claim 41 wherein the means for iterating further comprises means for iterating in either the forward or reverse direction as the portion of the document is received by a data processing device.

44. The apparatus for processing the XML document as in claim 40 further comprising means for providing a data guide structural summary that contains a namespace uri and name pair of at least some information items of the collection of ordered information items where each such pair has been assigned a unique value.

45. The apparatus for processing the XML document as in claim 44 further comprising means for substituting the unique value of the data guide structural summary as a short-hand reference in place of the name pair of the at least some information items.

46. An apparatus for processing the XML document in a collection of ordered information items, such method comprising:
means for providing a data guide structural summary that contains the namespace uri and name pair of information items where each such pair being assigned a unique value; and
means for using the data guide structural summary as a short-hand reference in place of the namespace uri and name pair contained in the information item.

47. An apparatus for processing the XML document in a collection of ordered information items, such apparatus comprising:
an information item of the collection of ordered information items encoded as a series of records where each record is provided with a length field at a beginning and at an end of the record; and
an application processing interface that processes at least a portion of the series of records, upon occasion, in a forward direction and, upon occasion, in a reverse direction based upon use of the length fields at the beginning and end of a record of the portion of the series of records.

48. An apparatus for representing an XML document in a collection of ordered information items, such apparatus comprising:
a stream counter that provides an offset of a parent information item from a child information item of the collection of ordered information items within a record of the series of records; and
a locating processor adapted to directly traverse from the child information item to the parent information item based upon the offset.

49. An apparatus for representing an XML document in a collection of ordered information elements, such method comprising:
a symbol table that contains the names of elements of the ordered information elements;
a plurality of atoms used as a short-hand reference in place of a name associated with or name contained in the information element of the collection of ordered information elements;
a substitution processor adapted to substitute the short-hand reference for the name associated with or name contained in the information element of the collection of ordered information elements into the information element.

50. An apparatus for representing an XML document in a collection of ordered information items, such method comprising:
a data guide structural summary that contains the namespace uri and name pair of information items where each such pair being assigned a unique value; and
a substitution processor that uses the data guide structural summary as a short-hand reference in place of the namespace uri and name pair contained in the information item.
